(19) United States
(12) Patent Application Publication
(10) Pub. No.: US 2022/0030847 A1
(43) Pub. Date: Feb. 3, 2022

(54) ADJUSTABLE TRIGGER PLATE FOR AN ANIMAL TRAP

(71) Applicant: AP&G Co., Inc., Brooklyn, NY (US)

(72) Inventor: Edward William Dolshun, Warwick, NY (US)

(21) Appl. No.: 17/393,140

(22) Filed: Aug. 3, 2021

Related U.S. Application Data
(60) Provisional application No. 63/060,430, filed on Aug. 3, 2020.

(51) Int. Cl. A01M 23/26

(52) U.S. Cl. CPC A01M 23/265; A01M 2200/00

(57) ABSTRACT

A mole trap formed of spring-biased jaws that are positioned underground. A trigger plate is mounted above and in line with the jaws. The trigger plate is extendable to reach farther into the ground and retractable back into a stored position. The adjustable trigger plate allows fine tuning of the trap for different conditions.

### RELATED APPLICATIONS

This application claims the benefit of pending U.S. Prov. Ser. No. 63/060,430 filed Aug. 3, 2020, the contents of which are incorporated by reference herein.

### FIELD OF THE INVENTION

The invention relates to the field of an animal trap, more specifically to a mole trap with an adjustable trigger mechanism for improved effectiveness.

### BACKGROUND OF THE INVENTION

Various devices have been developed which seek to trap moles in order to reduce damage to plants and landscaped areas, and to prevent loss of the structural integrity of soil resulting from mole tunnels.

Once such device captures a mole between vertically-oriented, spring-actuated jaws or scissors which are activated by a trigger mechanism. Generally, the trigger mechanism is horizontally oriented along the top of a mole run, and is activated by a mole pressing up against it from underneath. When the trigger mechanism is activated, the spring-actuated jaws clamp together, trapping the mole.

In existing devices, the trigger mechanism is set at a fixed length, and thus can only penetrate the ground to a certain depth. However, depending on the size of the mole or the depth of the tunnel the mole digs, the mole may be able to pass through the trap undetected and avoid setting off the trap, thus defeating the trap's purpose.

### SUMMARY OF THE INVENTION

Embodiments of the invention are directed to an adjustable trigger mechanism for an existing jaw-type mole trap, whose length can be easily changed to increase the likelihood of trapping a mole if the original length is unsuccessful.

The device is formed of a trigger mechanism centered between two pairs of vertically-oriented, opposing gripping jaws. When actuated, the trigger mechanism activates the springs, which close the jaws in unison. When set, the jaws straddle the mole tunnel, with the trigger mechanism aligned along the top.

The invention provides a method for the user to adjust the length of the trigger mechanism, allowing it to be set at different depths beneath the ground.

Thus, it is one object of the invention to provide a rodent trap having a first pair of angled members, comprising a first angled member and second angled member, the first angled member having a jaw member extending downwardly therefrom, the second angled member having a jaw member extending downwardly therefrom;

a second pair of angled members, comprising a third angled member and a fourth angled member the third angled member having a jaw member extending downwardly therefrom, the fourth angled member having a jaw member extending downwardly therefrom;

a first lever having a first end pivotably connected to the first angled member and the third angled member;

a second lever having a first end pivotably connected to the second angled member and the fourth angled member;

a hollow cylindrical member extending downwardly from the first lever, the hollow cylindrical member comprising an inner wall and outer wall whereby at least a portion of the inner wall is threaded;

a screw comprising a shaft having a first threaded end inserted into the hollow cylindrical member, and a second end comprising a trigger plate; and

whereby the trigger plate is movable in a first direction away from the cylindrical member by rotating the screw in a first direction and whereby the trigger plate is movable in a second direction toward the cylindrical member by rotating the screw in a second direction.

Other principal features and advantages of the invention will become apparent to those skilled in the art upon review of the following drawings and detailed description.

### BRIEF DESCRIPTION OF THE DRAWINGS

Illustrative embodiments of the invention will hereafter be described with reference to the accompanying drawings, wherein like numerals denote like elements.

FIG. 1 is a perspective view of a jaw-type trap known in the prior art for trapping animals, such as moles.

FIG. 2 is a perspective view of a trap with an adjustable trigger mechanism according to an exemplary embodiment of the invention.

FIG. 3 is a perspective view of a trap with a fully-extended adjustable trigger mechanism according to an exemplary embodiment of the invention.

FIG. 4 is an enlarged view of a trigger mechanism in accordance with an embodiment of the invention.

### DETAILED DESCRIPTION OF THE INVENTION

Embodiments of the present invention will now be described with reference to the above-identified Drawings. It will be understood that various modifications of the present description are possible without departing from the spirit of the invention. Also, features described herein may be omitted, additional features may be included, and/or features described herein may be combined in a manner different from the specific combinations recited herein, all without departing from the spirit of the invention.

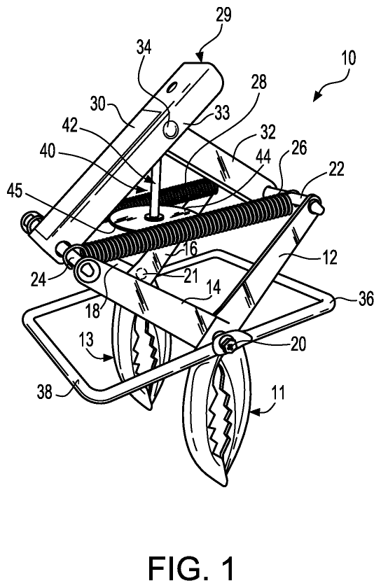

FIG. 1 shows a perspective view of a jaw-type trap 10, which is traditionally used in prior art to capture moles. As shown, trap 10 is comprised of jaws 11 and 13. Jaws 11 and 13 extend downward from angled members 12, 14, 16, and 18. Each angled member has a supporting end, and a jagged-edge or blade at the opposite end. Angled members 12 and 14 are hinged together at fastener 20, while angled members 16 and 18 are hinged together at fastener 21. U-shaped members 36 and 38 are horizontally aligned and planar to rods 22 and 24. Members 36 and 38 are connected to jaws 11 and 13 at fastener 20.

Bars 22 and 24 connect angled members 12 and 16, and 14 and 18, respectively, at the supporting ends. Springs 26 and 28 stretch perpendicularly from bar 22 to bar 24 on opposite sides of lever assembly 29. Lever assembly 29 is comprised of levers 30 and 32. The end of lever 30 is attached to bar 24, and the end of lever 32 is attached to bar 22. The second end of lever 32 and lever 30 are pivotally connected to bar 33 at fastener 34. Trigger mechanism 40 is pivotally connected and vertically suspended from bar 33.

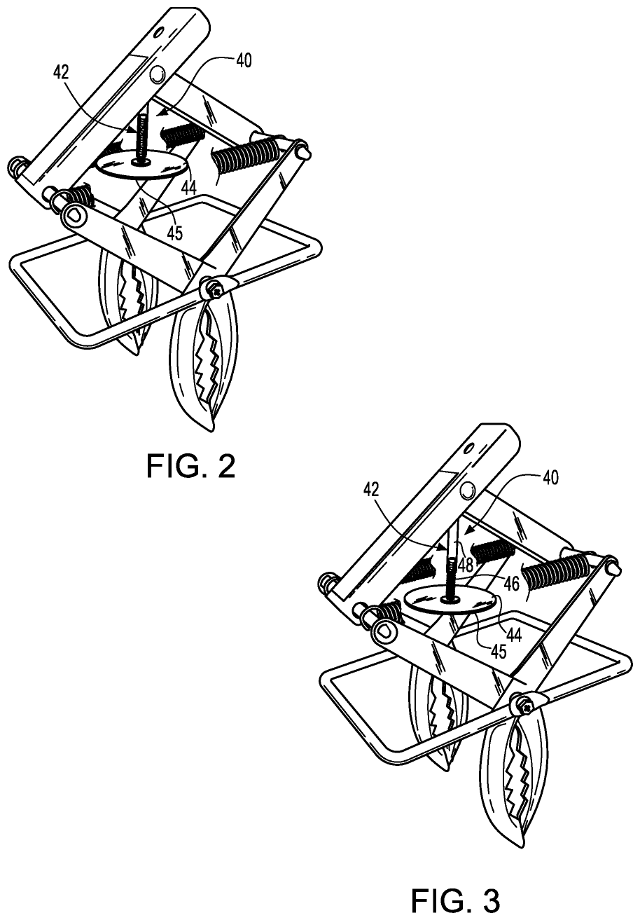

FIG. 2 is a perspective view of a trap with an adjustable trigger mechanism 40 according to an exemplary embodiment of the invention. In embodiments of the invention, trigger mechanism 40 is formed of a support rod 42 and plate 44. Support rod 42 is comprised of an externally threaded screw 46 and a hollow cylindrical member 48 that is internally threaded. Shank of screw 46 is incrementally smaller in diameter than the internal surface of the hollow cylindrical member such that the screw may move in and out of hollow cylindrical member 48. The top end of cylindrical member 48 is pivotally connected to bar 33. It will be understood that the measurements of screw 46 and its threads are such that it fits within member 48 and the threads intermesh respectively.

In embodiments of the invention, trigger mechanism 40 has a plate 44, with bottom surface 45, which is attached to the bottom end of screw 46. It will be understood that plate 44 may formed in any various geometric planar shapes, including, but not limited to, a circle, rectangle, or square.

In an exemplary set up of the trap, a user initially places jaws 11 and 13 beneath the ground where it wants to trap the animal. Once placed where desired, the user steps on lever 30 of lever assembly 29. This force pushes bars 22 and 24 away from each other, opening jaws 11 and 13. Trigger mechanism 40 is lowered by the downward movement of bar 33 and positioned above the mole tunnel. An upward force by a mole, or by other disturbances caused by the mole's movement against the bottom surface 45 of plate 44 of mechanism 40, subsequently creates an upward force on bar 33, collapsing the lever assembly 29 and activating the contraction of springs 26 and 28 to close jaws 11 and 13.

Embodiments of the invention provide a trigger mechanism 40 that is adjustable to allow the trigger plate 44 to assume any of various incremental positions.

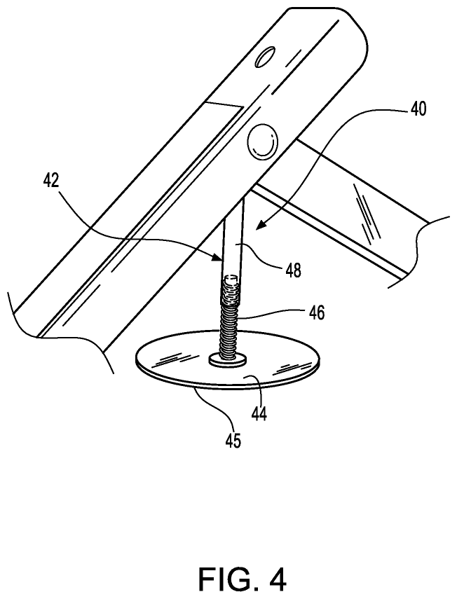

For example, as shown in FIG. 3, a trap in accordance with embodiments of the invention includes a trigger plate 44 connected to the trap through a threaded engagement. As shown, rod 42 is configured as a substantially hollow cylindrical member whereby at least a portion of its inner walls contain threads. A cooperating screw 46 is inserted into cylindrical member 48. In this regard, a first end of screw 46 is provided with threads that are configured to engage with threads on the inner surface of cylindrical member 48. A second end of screw 46 is connected to a trigger plate 44. In embodiments of the invention, terminal end of screw 46 is connected in the general center of bottom surface 45 of trigger plate 44.

In embodiments of the invention, trigger plate 44 is adjustable by rotating the screw in a first direction (e.g. clockwise) to move the screw 46 (and connected trigger plate 44) in a direction away from the rod 42; and by rotating the screw 46 in a second direction (e.g. counter-clockwise) to move the screw 46 (and connected trigger plate 44) in a direction toward the rod 42.

FIG. 2 shows in embodiment of the invention whereby screw 46 is retracted and substantially housed within rod 42. It will be understood that in a fully retracted (i.e. stored) position, screw 46 is substantially seated within rod 42, whereas, in an extended position, a majority of the screw 46 extends from rod 42, thereby effectively extending the length cylindrical member 48.

FIG. 3 is a perspective view of a trap with a fully-extended adjustable trigger mechanism 40 according to an exemplary embodiment of the invention. In use, trigger mechanism 40 is adjustable to allow it to be set to different depths, thereby adjusting its sensitivity to movement beneath the ground's surface. For example, if a user sets the trap and is unsuccessful in capturing a mole, the user may unscrew screw 46 to lengthen the support rod 42 of trigger mechanism 40, such that plate 44 of mechanism 40 may reach further beneath the ground. This adjustment may increase the likelihood of capturing a mole if the trigger mechanism was not previously able to be activated at the fixed length of member 48.

It will be understood by those of ordinary skill in the art that embodiments of the invention provide a trigger plate that may be extended at any of various increments. This may be achieved by turning the screw 46 in any of various desired incremental rotations.

It will be understood that the invention relates to a trap having a trigger plate 44 that is downwardly adjustable to maintain any of various planar z-axis positions in a set of z-axis positions.

In embodiments of the invention, a trigger plate may be mounted to any of various telescoping members which provide the ability to, respectively, extend and retract an attached trigger plate.

Having described the subject matter of the application with regard to specific embodiments, it is to be understood that the description is not meant as a limitation since further modifications and variations may be apparent or may suggest themselves to those skilled in the art. It is intended that the present application cover all such modifications and variations.

What is claimed is:

1. A rodent trap, comprising:
a first pair of angled members, comprising a first angled member and second angled member, the first angled member having a jaw member extending downwardly therefrom, the second angled member having a jaw member extending downwardly therefrom;
a second pair of angled members, comprising a third angled member and a fourth angled member the third angled member having a jaw member extending downwardly therefrom, the fourth angled member having a jaw member extending downwardly therefrom;
a first lever having a first end pivotably connected to the first angled member and the third angled member;
a second lever having a first end pivotably connected to the second angled member and the fourth angled member;
a hollow cylindrical member extending downwardly from the first lever, the hollow cylindrical member comprising an inner wall and outer wall whereby at least a portion of the inner wall is threaded;
a screw comprising a shaft having a first threaded end inserted into the hollow cylindrical member, and a second end comprising a trigger plate; and
whereby the trigger plate is movable in a first direction away from the cylindrical member by rotating the screw in a first direction and whereby the trigger plate is movable in a second direction toward the cylindrical member by rotating the screw in a second direction.

2. The rodent trap of claim 1 further comprising a first bar for pivotably connecting the first lever to the first angled member and the third angled member and a second bar for pivotably connecting the second lever to the second angled member and the fourth angled member.

3. The rodent trap of claim 2, further comprising a spring disposed between the first bar and the second bar.
